(19) United States
(12) Patent Application Publication
(10) Pub. No.: US 2024/0379027 A1
(43) Pub. Date: Nov. 14, 2024

(54) WINDSHIELD STICKER LICENSE PLATE

(71) Applicant: Daniel King, Bakersfield, CA (US)

(72) Inventor: Daniel King, Bakersfield, CA (US)

(21) Appl. No.: 18/144,490

(22) Filed: May 8, 2023

(51) Int. Cl. G09F 3/00; B60R 13/10; G09F 3/10

(52) U.S. Cl. CPC G09F 3/0297; B60R 13/10; G09F 3/10; G09F 2003/0202

(57) ABSTRACT

The present invention relates to a vehicle license plate that is designed to be affixed to the inside of a vehicle's windshield. Specifically, the front license plate of a vehicle is created as a sticker number plate, which includes a sticker seal and may also have the identification code and vehicle identification number printed on it. This sticker number plate is attached to the inside of the vehicle windshield by an adhesive portion.

### FIELD OF THE INVENTION

The present invention pertains to a vehicle license plate, and more specifically to a license plate designed as a sticker that may be affixed to the inside windshield of a vehicle.

### BACKGROUND OF THE INVENTION

At present, 32 States, including the State of California requires all registered passenger vehicles to attach a front and rear license plate. In all cases, non-compliance with this law is a violation of the vehicle code. Currently, vehicle license plates are made of aluminum. Front license plates are typically attached to either the middle, or to one side of the vehicle's front bumper via screws or other fasteners.

In spite of this current provision, it is quite common to see vehicles on the roads that do not have a front license plate attached to the front bumper. Many vehicle owners deliberately choose to relocate their front license plate inside the vehicle, often placed loosely on the dashboard, in an attempt to comply with the law. Many believe this will satisfy the current law, and many are even willing to risk violating the law, even if it means paying a fine for non-compliance.

In other cases, front the license plate may have been lost or damaged in a collision. Minor fender-benders, even those resulting in almost no damage to the vehicle bumper, can cause significant damage to the traditional license plate. Furthermore, front license plates dislodged in an accident are commonly left at the scene, particularly front license plates.

Deliberate license plate theft is also a common occurrence in our state. Many people have experienced license plate theft where many cars were parked together, such as malls, shopping centers, amusement parks, etc.

Another significant item that could be included on the license plate sticker would be the addition of the VIN or Vehicle Identification Number. Including the VIN would provide an additional security element. Comparing the VIN number stamped on the driver's side of the vehicle dashboard with the VIN on the license plate sticker would enable instant verification of authenticity. A license plate “sticker,” attached to the inside of the windshield of California registered vehicles could elegantly resolve all these problems and issues.

### SUMMARY

The present invention discloses a vehicle license plate designed as a sticker that may be affixed to the inside of a vehicle's windshield, serving as the front license plate. The sticker can exist as either an alpha-numeric plate, a barcoded plate, a QR-coded plate, or any-and-all permutations of these and other informational elements. The sticker could feature an official State seal and may include a barcode on its face. The included adhesive is formulated to cure over the course of an hour or two after the license plate sticker is attached, to securely and permanently attach to the inside of the vehicle's windshield. It could also be reconfigured to attach to the outside of the windshield if the state decides this is a more favorable location for the sticker.

### BRIEF DESCRIPTION OF THE DRAWINGS

FIG. 1 shows a schematic prior art front view of a vehicle with a conventional mounted license plate.

FIG. 2 shows a schematic front view of a vehicle with a license plate in accordance with the present invention mounted in a bottom far-left position.

FIG. 3 shows a schematic front view of a vehicle with a license plate in accordance with the present invention mounted in a top far-left position.

FIG. 4 shows a schematic front view of a vehicle with a license plate in accordance with the present invention mounted in a center top position.

FIG. 5 illustrates a front planar view of a license plate sticker according to the present invention before attachment to the interior of a vehicle windshield.

### BRIEF DESCRIPTION OF THE PREFERRED EMBODIMENTS

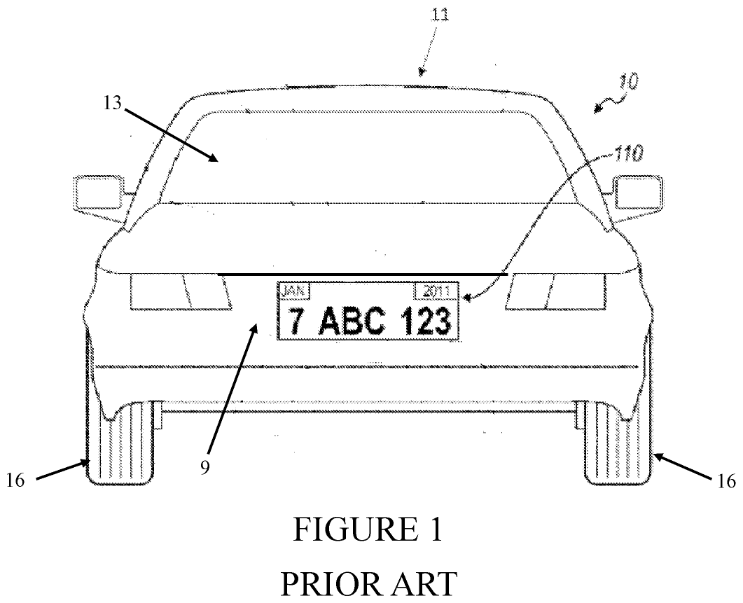

The present invention will now be described in detail with reference to the accompanying drawings. FIG. 1 illustrates a prior art vehicle car 10 with a conventional metal license plate 110 attached to a bolted housing frame (not shown) on the front bumper 9. The vehicle car 10 also includes a roof 11, a windshield 13, and tires 16.

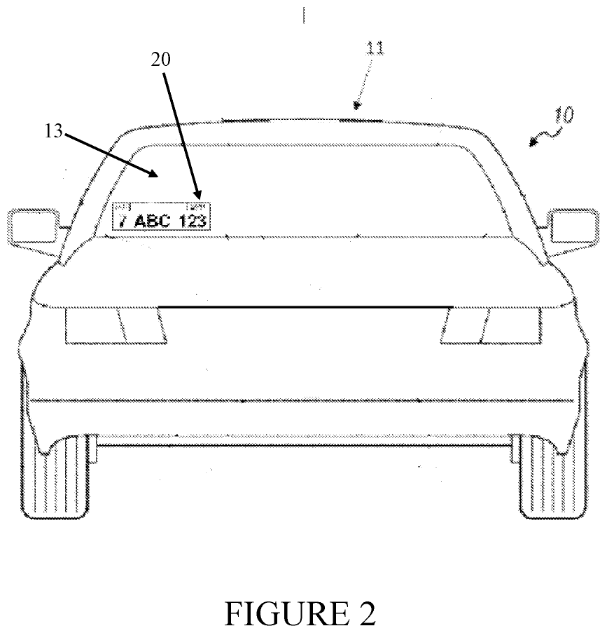

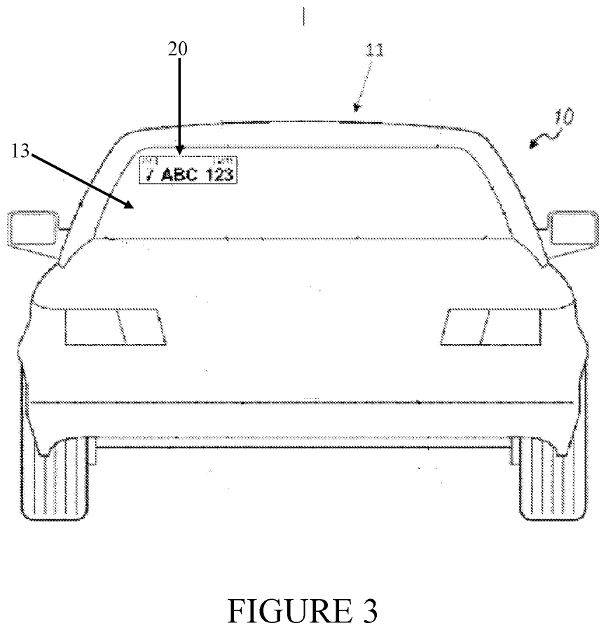

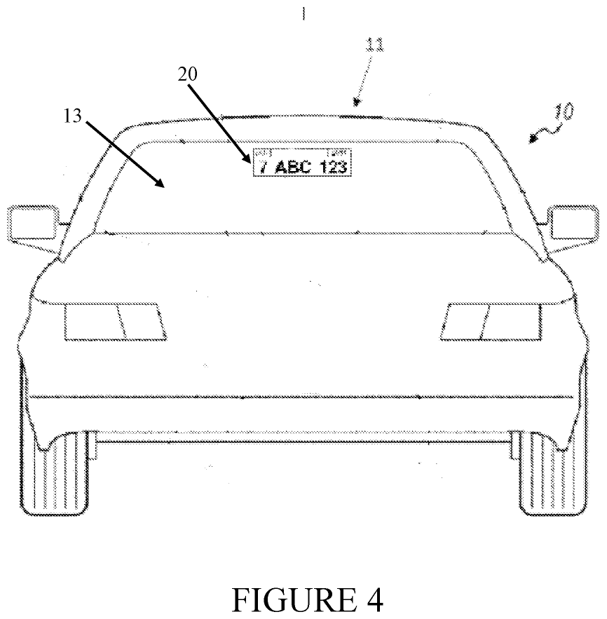

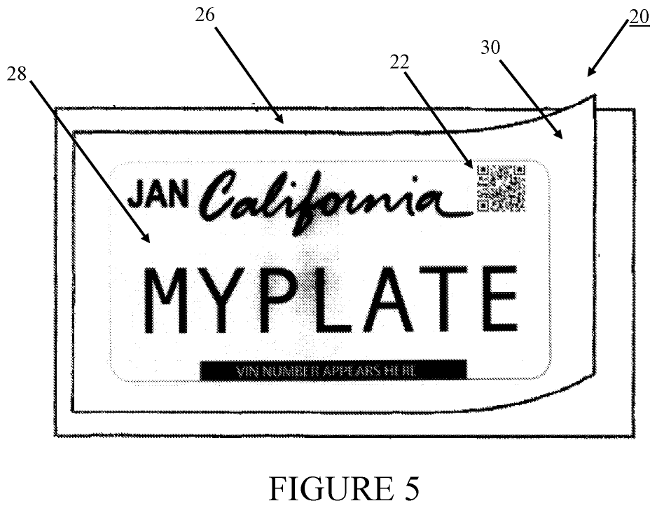

Turning now to FIGS. 2 through 5 there is shown a schematic front view of a vehicle car 10 equipped with a license plate sticker 20 in accordance with the present invention. The license plate sticker 20 is in the form of a license plate sticker 20 and is attached to the inside of the windshield 13 at different locations. The license plate sticker 20 may include a sticker-type seal portion and a barcode or QR code 22 as shown in FIG. 5. The license plate sticker 20 may include letters and numbers and may be color-coded for commercial or private use.

In a preferred embodiment, the manufacturing method for the sticker-type plate includes printing numbers, letters, identification codes, and seals on a color-coded background. The sticker may be made using a variety of methods, such as a separate method for displaying an identification code and seal designed to break when detached to prevent theft of the license plate.

Referring now to FIGS. 2 through 5, a front installed view of the front license plate sticker in accordance with the present invention is once again depicted. Referring now to FIG. 5, there is shown a front planar of the license plate sticker 20 before installation having an adhesive bottom portion 26, vinyl license plate center portion 28 and peeling paper top portion 30. The peeling paper is shown and is peeled off allowing the adhesive bottom portion to attach to the windshield displaying and affixing the vinyl license center portion 28 for display.

The size of the license plate sticker could literally be any size and in a preferred embodiment is smaller than the traditional front license plate. In yet another preferred embodiment, the license plate sticker could share the same dimensions as a motorcycle license plate, which is legally accepted in California and other states. The adhesive used to adhere the sticker to the windshield should be applied to the printed side of the windshield sticker and be applied proportional to the size of the license plate sticker.

As previously described, the present invention involves configuring the front license plate of a conventional vehicle in the form of a sticker-type seal that is adhered to the inside of the vehicle car windshield. By incorporating a sticker-type seal and bar code, the license plate becomes a more efficient and effective tool for tracking and identification purposes. In another embodiment of the present invention, by replacing the traditional metal license plate with a simple sticker, production costs, and attachment devices may be reduced. Additionally, the present invention includes a useful design feature, such as an identification code and/or vehicle identification number such as a QR code by way of example but not of limitation printed on the front of the sticker, which facilitates vehicle tracking from a distance. Including the VIN number on the sticker license plate will provide instant verification of both the window sticker license plate as well as the metal plate attached to the rear of the vehicle, further reducing incidents of undetected fraud.

Therefore, it is understood that in certain State, and including the State of California, significant benefit can be gained from adopting an alternative product that would seamless resolve many issues currently experienced in the current front license plate 110 implementation. The solution proposed will continue to do the following:
1. Provide Federal, State and local authorities, with and additional tool to positively identify a vehicle, particularly from the frontal area
2. Provide a solution to satisfy the public desire to preserve the appearance of the front of the vehicle
3. Eliminate a safety risk to vehicle occupants associated with the common practice of placing loose and dangerous metal license plates on the vehicle dashboard
4. Provide a replacement alternative that is more easily secured to the vehicle, less susceptible to damage, loss, theft, or other common causes of missing front license plates
5. Provide on-the-spot verification of both the authenticity of the windshield sticker license plate, as well as the authenticity of the attached rear license plate

The window sticker license plate could be produced as a traditional sized place, but this may reduce the driver's visibility of the road. A reduced size plate sticker most likely be more practical. One option would be to make it the same size as the plates currently used on motorcycles, off-road vehicles, and small trailers. This size plate has already been endorsed by law enforcement and would address the visibility restriction issue more adequately. Further, it could occupy a space on the windshield that vehicle dealerships currently use to affix temporary a registration document to the vehicle's windshield.

To address any counterfeiting or other security concerns, the windshield plate could be produced using the same film materials currently in use to produce metal license plates, just reduced in size to address the needs outlined above. Furthermore, the ordering and manufacturing of windshield plates could be integrated into the current processes used by the State. Window license plate sticker orders could be validated for authenticity with the State before being fulfilled by a third-party manufacturer. Window sticker license plates can be securely produced at scale, and fulfilled in lock-step with current license plate distribution practices. Moreover, the windshield plate design, text and artwork will mirror the design of the traditional plate assigned to the vehicle by the State vehicle licensing authority.

What is claimed is:

1. A windshield license plate for a vehicle, comprising a front license plate configured in the form of a license plate sticker sized for placement inside of said vehicle windshield.

2. The windshield license plate according to claim 1, wherein said size of said license plate sticker is legally accepted in California.

3. The windshield license plate according to claim 1, wherein said license plate sticker is smaller in size than a conventional vehicle license plate.

4. The windshield license plate according to claim 1, wherein said license plate sticker is the same size as a motorcycle license plate.

5. The windshield license plate according to claim 1, wherein said license plate sticker includes a barcode for vehicle tracking.
